(19) United States
(12) Patent Application Publication
(10) Pub. No.: US 2024/0132678 A1
(43) Pub. Date: Apr. 25, 2024

(54) SYNERGISTIC DUAL CURE FOR RAPID MANUFACTURING OF THERMOSET MATERIAL

(71) Applicant: Alliance for Sustainable Energy, LLC, Golden, CO (US)

(72) Inventors: Robert David ALLEN, Golden, CO (US); Nicholas A. RORRER, Golden, CO (US); Michael McGRAW, Lakewood, CO (US)

(21) Appl. No.: 18/483,151

(22) Filed: Oct. 9, 2023

Related U.S. Application Data
(60) Provisional application No. 63/414,238, filed on Oct. 7, 2022.
(60) Provisional application No. 63/510,203, filed on Jun. 26, 2023.

(51) Int. Cl. C08J 3/24; C08J 3/28

(52) U.S. Cl. CPC C08J 3/246; C08J 3/28; C08J 2333/12; C08J 2367/00; C08J 2433/12; C08J 2467/00

(57) ABSTRACT

Described herein are compositions and methods that utilize complementary polymerization reactions to simultaneously generate one or more polymeric materials, including crosslinked polymer matrices, tethered inter-penetrating network, heterogenous polymer blends, or homogeneous polymer blends. The provided compositions and methods utilize the combination of an energy demanding step-growth reaction with a highly exothermic reaction to drive the energy demanding reaction by chemical heating and avoid issues associated with thermal runaway, such as solution boiling or unwanted biproducts.

### CROSS-REFERENCE TO RELATED APPLICATIONS

This application claims priority from U.S. Provisional Patent Application Nos. 63/414,238, and 63/510,203 filed on Oct. 7, 2022, and Jun. 26, 2023, respectively, the contents of which are incorporated herein by reference in their entirety.

### CONTRACTUAL ORIGIN

This invention was made with government support under Contract No. DE-AC36-08GO28308 awarded by the Department of Energy. The government has certain rights in the invention.

### SUMMARY

Described herein are compositions and methods that utilize complementary polymerization reactions to simultaneously generate one or more polymeric materials, including crosslinked polymer matrices, tethered inter-penetrating network, heterogenous polymer blends, or homogeneous polymer blends. The provided compositions and methods utilize the combination of an energy demanding reaction with a highly exothermic reaction to drive the energy demanding reaction by chemical heating and avoid issues associated with thermal runaway, such as solution boiling or unwanted biproducts. The energy-demanding exothermic reaction may be photoinitiated, by including a photoinitiator and exposing the reactants to electromagnetic radiation, e.g., ultraviolet light. The energy-demanding exothermic reaction may be thermally, chemically and/or photochemically initiated with a free radical source. For the purpose of clarity, an energy-demanding exothermic reaction refers to a reaction that requires activation energy but then releases additional energy via the reaction. The energy-demanding reaction may be a step-growth reaction.

In some cases where the system is opaque and light penetration is limited, thermal energy may be preferable, or a combination of light and thermal energy may be used to initiate the reaction. For opaque systems, light may still be used as only a small amount of light may be required to begin the exothermal reaction. For example, light penetration of only a few μm, for example about 5 μm may be required.

In an aspect, provided is a method comprising: a) providing one or more first reactants, wherein the one or more first reactants are capable of exothermic polymerization; b) providing one or more second reactants, where in the one or more second reactants are capable of energy-demanding step growth polymerization (i.e., sluggish, or contains a high activation barrier for polymerization); c) combining the one or more first reactants and the one or more second reactants in a vessel; and d) reacting the one or more first reactants, thereby generating a first polymer and thermal energy; wherein the thermal energy induces the one or more second reactants to react thereby generating a second polymer. The first polymer may be covalently bound to the second polymer, thereby generating a tethered inter-penetrating network or a tethered comingled polymer network.

The method may further comprise providing a free radical source and the one or more first reactants may be capable of free radical polymerization. The free radical source may comprise simple thermal initiators such as A1BN, photoinitiators such as DMPA, or may comprise a redox amine/peroxide pair such as dimethyl aniline/benzoyl peroxide.

The one or more first reactants may comprise one or more vinyl monomers or polar vinyl monomers. Examples of vinyl monomers include methacrylates, acylates, acrylamides, as well as stryrenic monomers, or a combination thereof. The one or more first reactants may further comprise a bonding reactant capable of forming a covalent bond with the second polymer, for example, an anhydride, an epoxide, an alcohol, a carboxylic acid, or an amine. Additional examples of bonding reactants include methyl methacrylate, ethyl methacrylate, methacrylic anhydride, isobornyl acrylate, or combinations thereof.

The one or more second reactants may comprise the PECAN polymer system as described herein. For example, the one or more second reactants may comprise (2R,3S,4S,5S)-2-(cycloproylmethoxy)-1,5,6-tris(oxiran-2-ylmethoxy)hexane-3,4-diol (FX1), 5-methylhexahydroisobenzofuran-1,3-dione (FX2), 4-ethyl-2-methyl-1H-imidazole (FX3); 1,4-bis(oxiran-2-ylmethoxy)butane (FX4) or a combination thereof.

The one or more first reactants and the one or more second reactants may be provided in a ratio such that the solution comprising the one or more first reactants, the one or more second reactants, the first polymer and the second polymer stays below boiling temperature.

The reactants may also be strategically divided so as to accommodate the formation of an interpenetrating network or a phase-separated product. For example, in the case where the second reactants comprise epoxides and acrylates and/or anhydrides, the reactants may be divided into a first group comprising the epoxides and the free radical initiator and a second group comprising the first reactants including the bonding agent and the acrylates and/or anhydrides. Mixing the two separated groups to initiate the reaction will promote the formation of a tethered inter-penetrating network.

The first exothermic reaction may comprise a photoinitiator and further comprise exposing the first reactants to electromagnetic radiation, e.g., light. As described herein, an example photoinitiator is 2,2-Dimethoxy-2-phenylacetophenone (DMPA).

In an aspect, provided is a composition comprising: a) a first polymer network; and b) a second polymer; wherein the second polymer is covalently bound to the first polymer network to form a tethered inter-penetrating network.

The first polymer network and/or second polymer network may comprise the PECAN polymer system as described herein. For example, the one or more second reactants may comprise (2R,3S,4S,5S)-2-(cycloproylmethoxy)-1,5,6-tris(oxiran-2-ylmethoxy)hexane-3,4-diol (FX1), 5-methylhexahydroisobenzofuran-1,3-dione (FX2), 4-ethyl-2-methyl-1H-imidazole (FX3); 1,4-bis(oxiran-2-ylmethoxy)butane (FX4) or a combination thereof. The first polymer network may be photoinitiated, wherein the first reaction may further comprise a photoinitiator.

The second polymer may comprise a polymer formed by an exothermic free radical reaction comprising methacrylate monomers, for example, methyl methacrylate, ethyl methacrylate, methacrylic anhydride, isobornyl acrylate or a combination thereof.

### BRIEF DESCRIPTION OF DRAWINGS

Some embodiments are illustrated in referenced figures of the drawings. It is intended that the embodiments and figures disclosed herein are to be considered illustrative rather than limiting.

FIG. 1 provides an example of the reaction chemistry of the example PECAN polymer system.

FIG. 2 provides an exemplary dual cure reaction using PECAN and methyl methacrylate in a one-pot reaction, as well as photographs of the resulting products.

FIG. 3 provides an exemplary dual cure reaction using PECAN and methyl methacrylate and 10 mol % methacrylic anhydride in a one-pot reaction, as well as photographs of the resulting products.

FIG. 4 provides examples of bonding reagents (referred to as trojan horse monomers) useful in forming covalent bonds from the two resulting polymers, as described herein.

FIG. 5 provides additional bonding reagents (trojan horse monomers) including methacrylic anhydride (MAAn) and isobornyl acrylate.

FIG. 6 shows Dynamic Scanning Calorimetry isotherm (80° C.) curves for the polymerization of ethyl methacrylate (EMA) mixed in various compositional ratios (w/w) with PECAN.

FIG. 7A provides an example utilizing the described methods to form a phase separated mixture.

FIG. 7B provides an example utilizing the described methods to form a tethered inter-penetrating network.

FIG. 8 provides an example of strategic separation of the reactants prior to performing the reaction, so as to form a tethered inter-penetrating network.

FIG. 9 provides an example graph describing the relationship between temperature and time for a photoinitiated first reaction step.

FIG. 10 provides additional temperature over time for the photoinitiated first reaction described in FIG. 9.

FIG. 11 provides an exemplary reaction for a photoinitiated dual cure system, including example weight percentages of various reactants as well as a photo of the resulting polymer system.

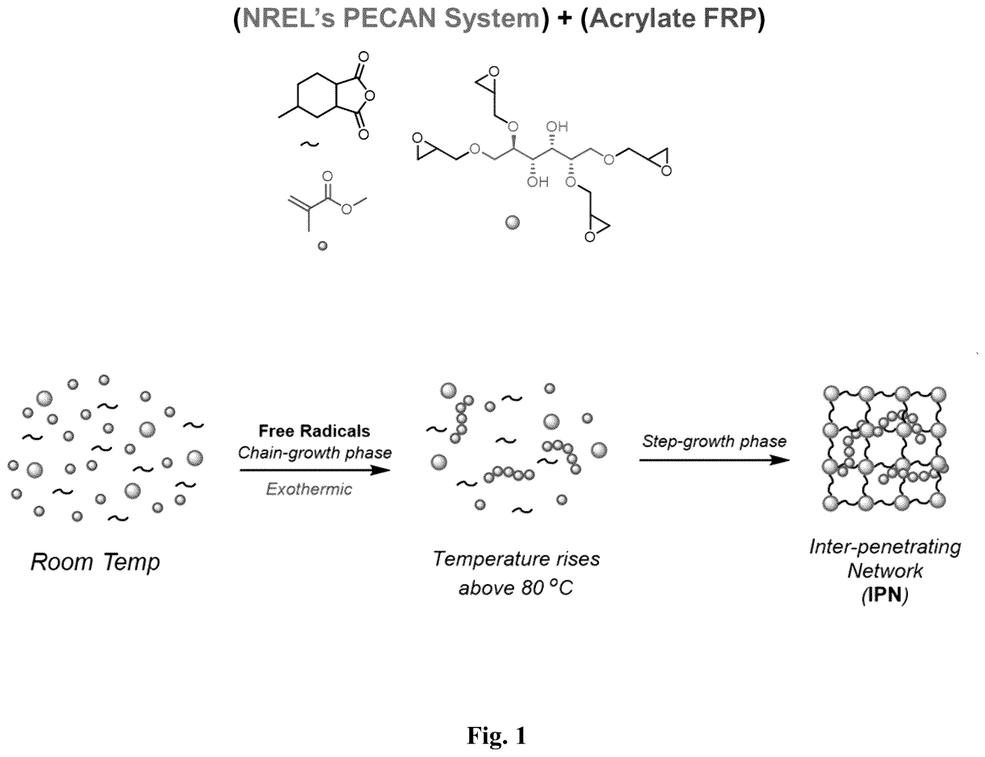

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

As used herein, “PECAN polymer system” or “PECAN” refers to a polyester covalently adaptable network polymer or polymer matrix formed from one or more of the following monomers:

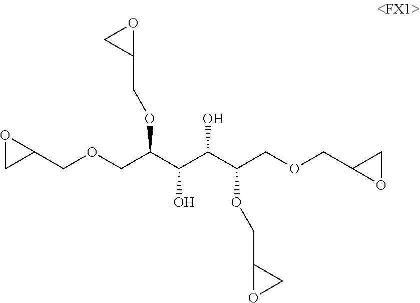 [SMILES: O[C@@H]([C@H](O)[C@@H](COCC1CO1)OCC1CO1)[C@H](COCC1CO1)OCC1CO1]

or (2R,3S,4S,5S)-2-(cycloproylmethoxy)-1,5,6-tris(oxiran-2-ylmethoxy)hexane-3,4-diol;

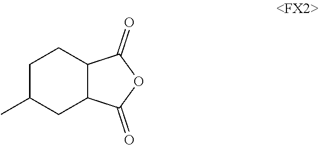

or 5-methylhexahydroisobenzofuran-1,3-dione;

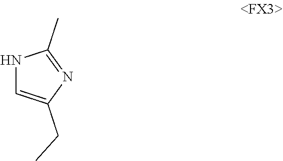

or 5-methylhexahydroisobenzofuran-1,3-dione (FX2), 4-ethyl-2-methyl-1H-imidazole; and

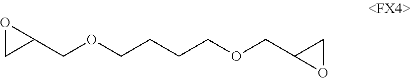 [SMILES: C(CCOCC1CO1)COCC1CO1]

or 1,4-bis(oxiran-2-ylmethoxy)butane. The monomer described by FX1 may be provided in a range selected from 35 wt % to 45 wt %, 25 wt % to 50 wt %, 36 wt % to 41 wt %, or optionally, about 39 wt %. The monomer described by FX2 may be provided in a range selected from 40 wt % to 50 wt %, 35 wt % to 50 wt %, 43 wt % to 47 wt %, or optionally, about 45 wt %. The monomer described by FX3 may be provided at less than or equal to 10 wt %, 5 wt %, 3 wt %, or optionally, about 1 wt %. The monomer described by FX4 may be provided in a range selected from 10 wt % to 20 wt %, 5 wt % to 25 wt %, 13 wt % to 17 wt %, or optionally, about 15 wt %. PECAN STGE-39 refers to a specific exemplary formulation where the monomers are provided at the following quantities: FX1-39 wt %, FX2-35 wt %, FX3-1 wt % and FX4-15 wt %.

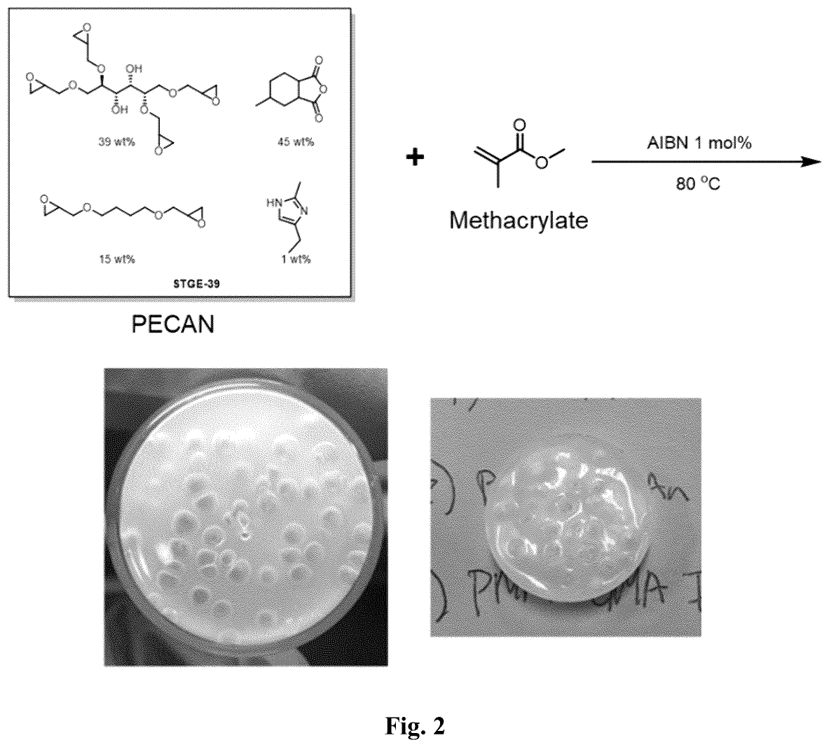

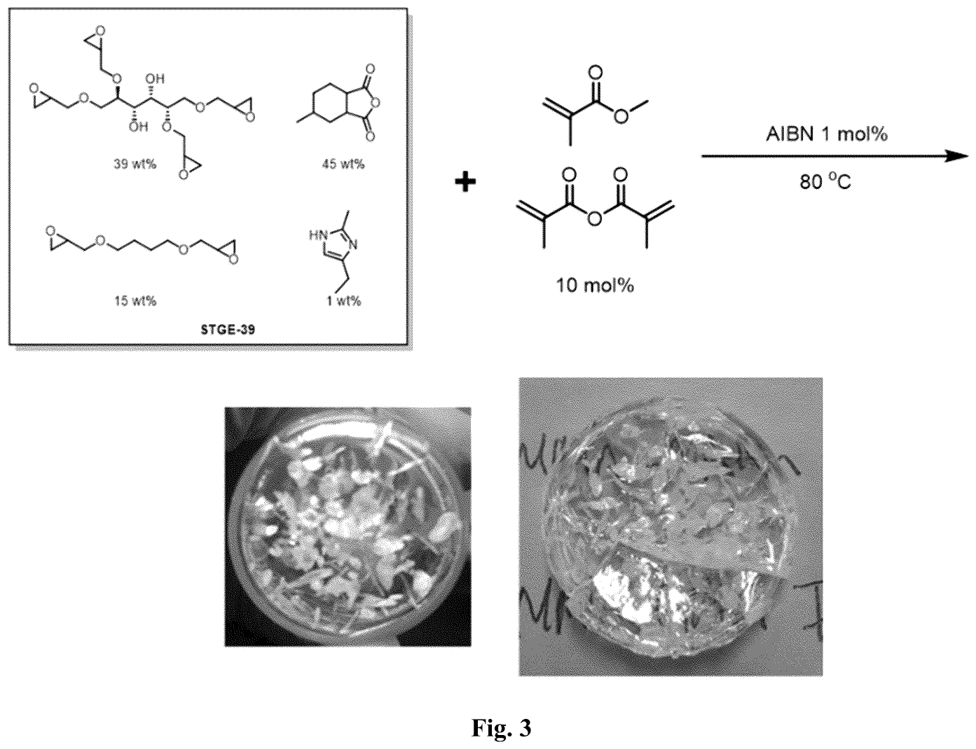

Example of a dual cure reaction utilizing the PECAN polymer system is provided in FIG. 2. The PECAN and methacrylate composition is STGE-39/MMA 1/1 by weight. AIBN is used as a radical source, 80° C. is used to activate AIBN and induce PECAN polymerization. Both systems achieve full conversion after 12 h. Bubbles in the material are caused by methacrylate boiling. Note the opaque white nature of the product. Similarly, FIG. 3 provides an example including 10 mol % methacrylic anhydride included as a bonding reagent to form covalent bonds between the two resulting polymers. The PECAN and methacrylate composition is STGE-39/MMA 1/1 by weight. AIBN is used as a radical source, 80° C. is used to activate AIBN and induce PECAN polymerization. Both systems achieve full conversion after 12 h. Note the transparent nature of the product.

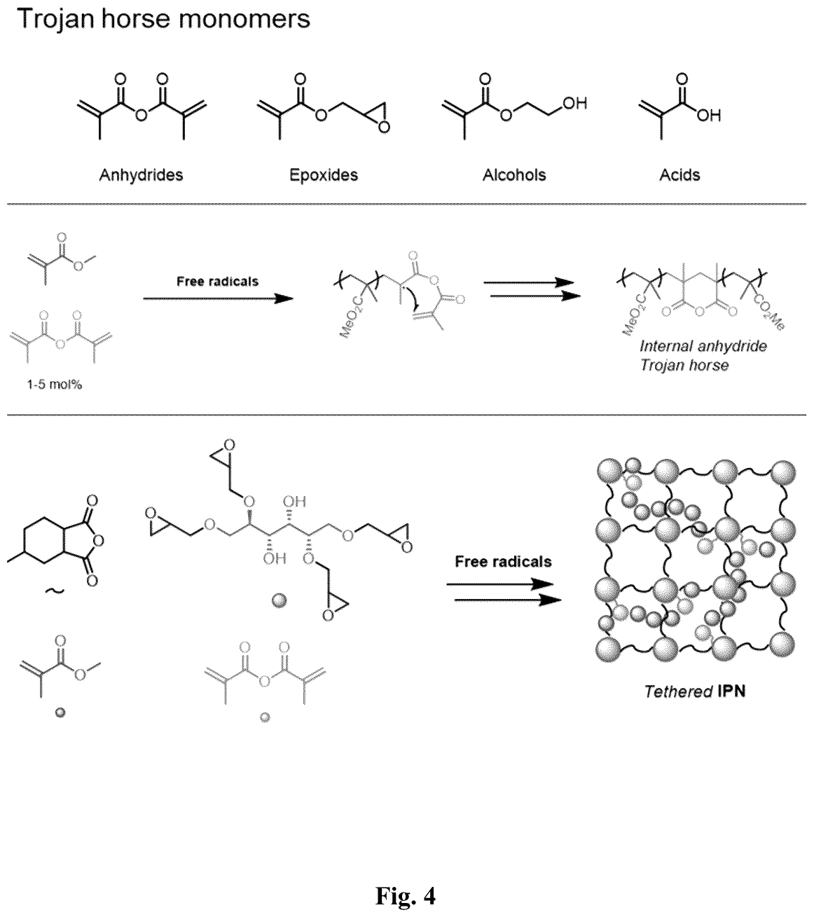

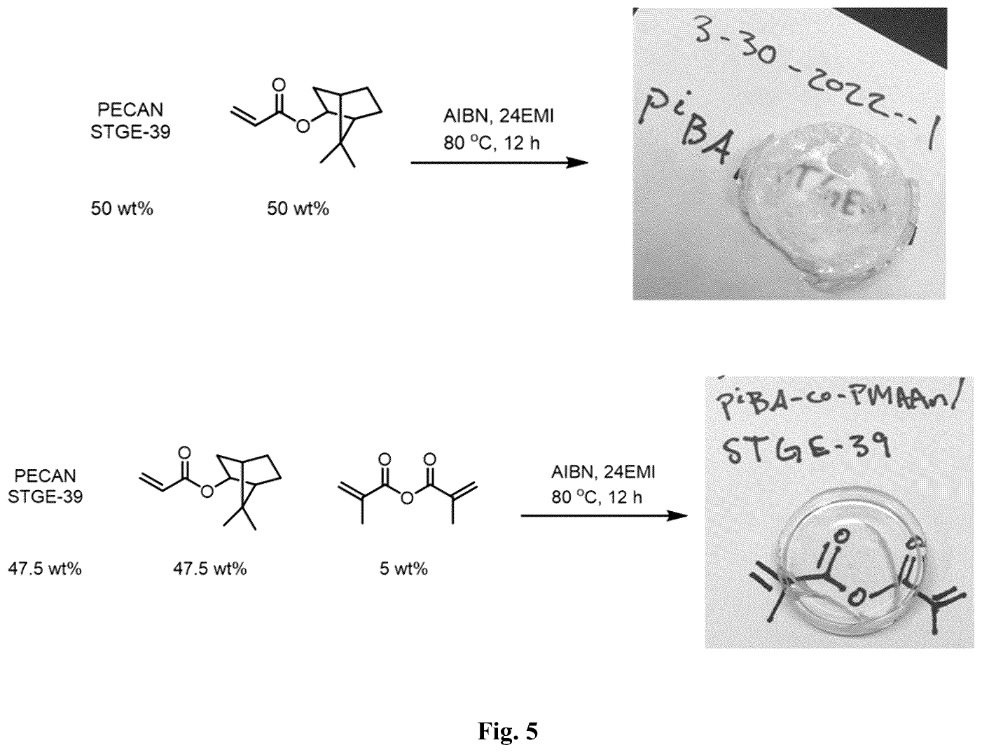

Example of bonding reagents (or trojan horse molecules) are provided in FIG. 4. The Trojan horse concept uses a functionalized methacrylate that will form a covalent bond with the PECAN network to force mixing between the methacrylate polyolefin chains and the PECAN polyester network. This is presumably what accounts for the transparency or the materials when a Trojan horse is employed.

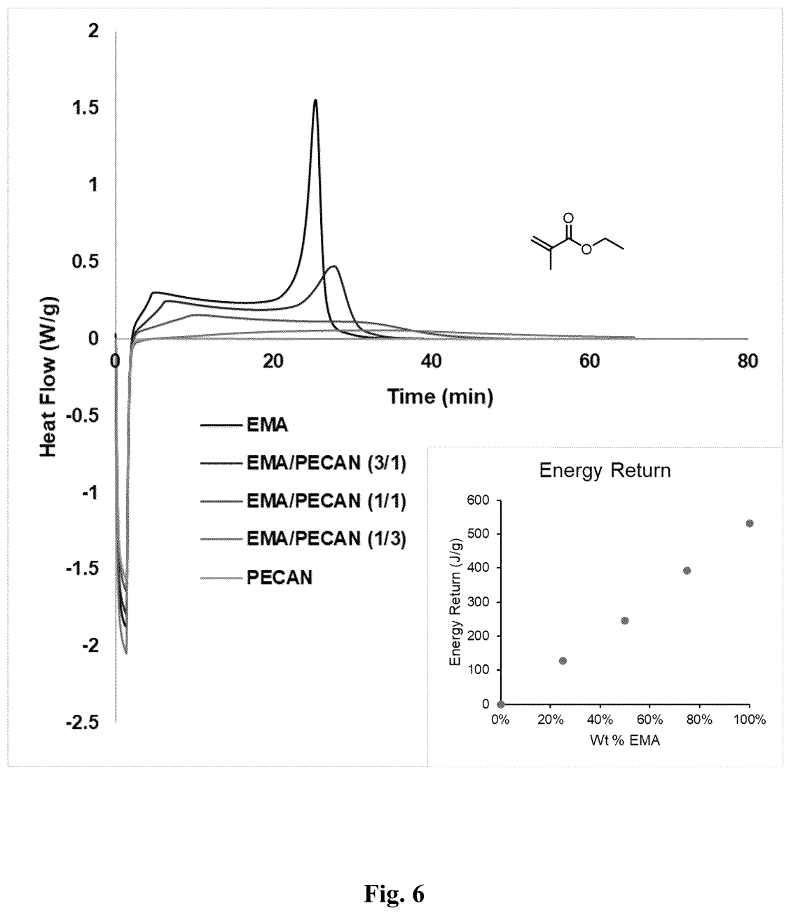

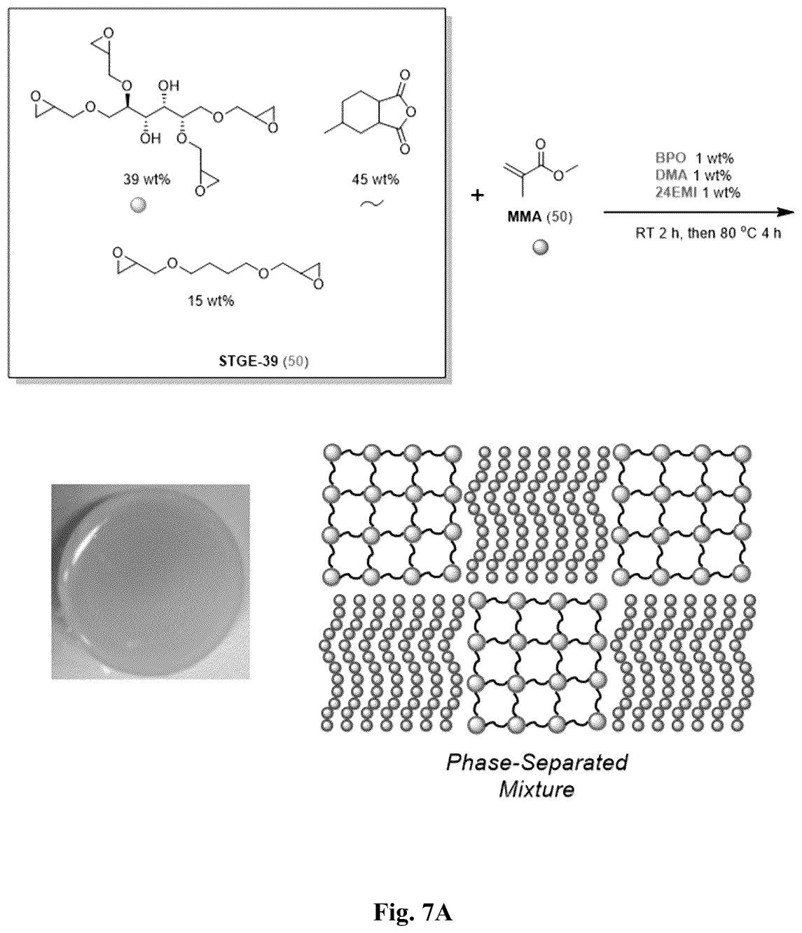

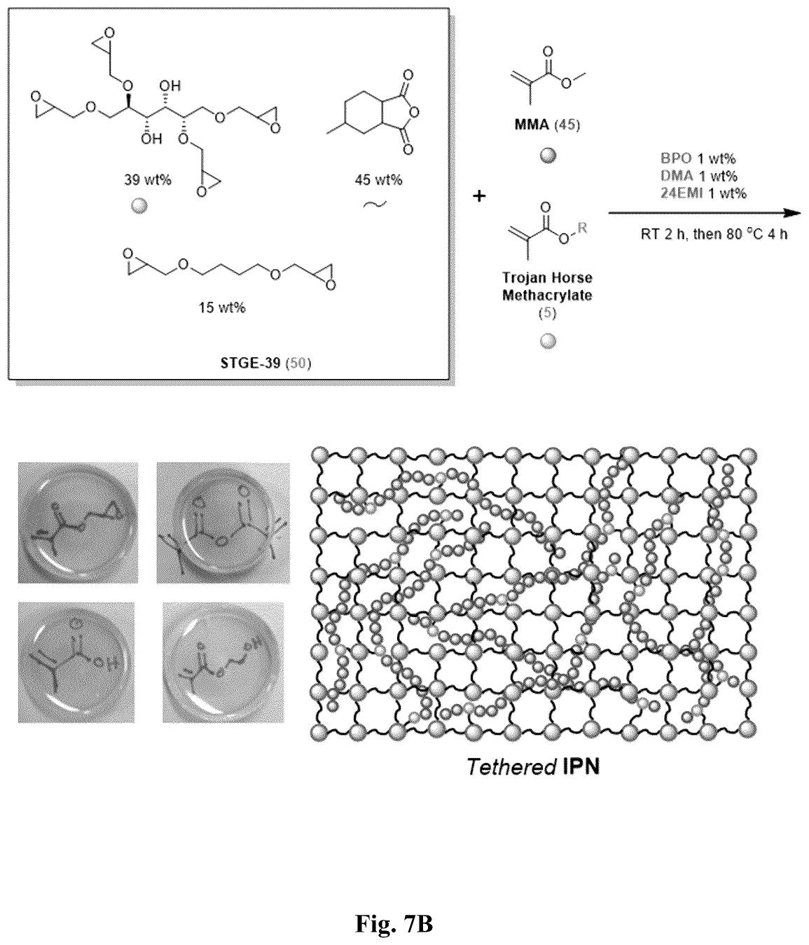

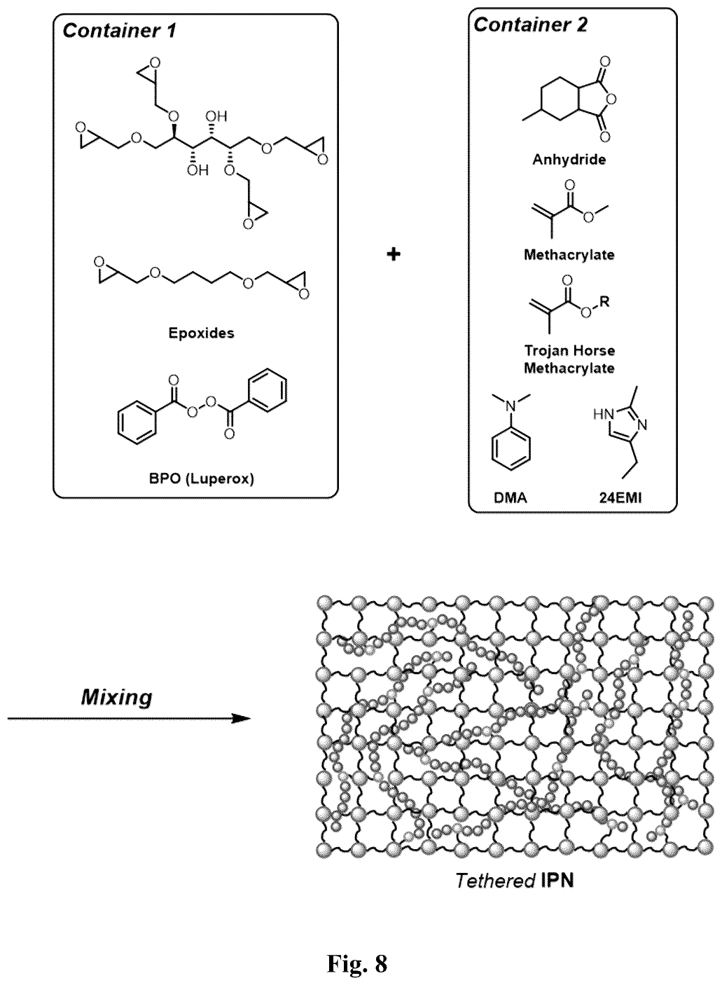

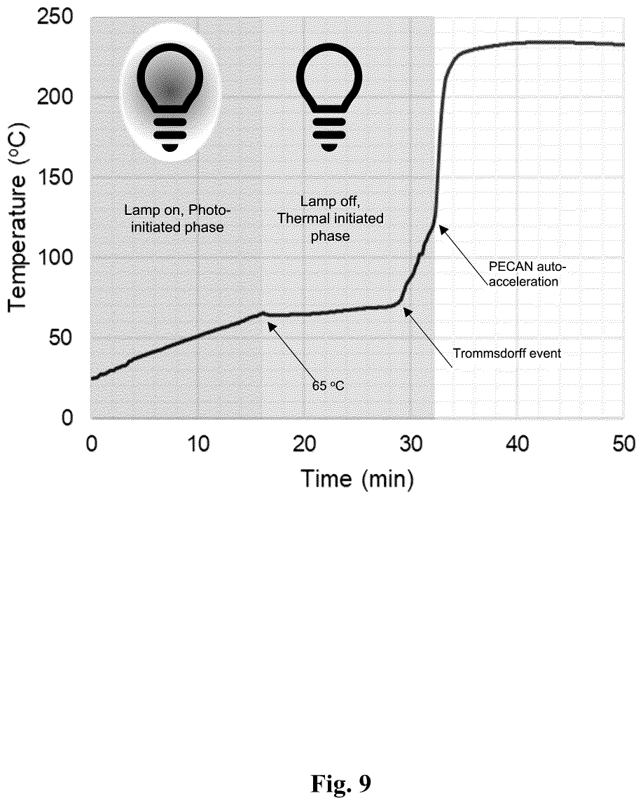

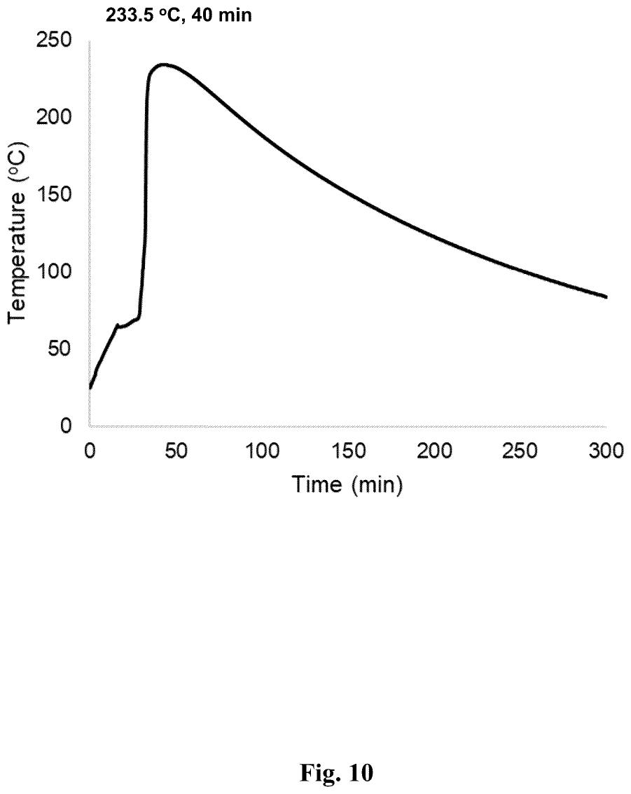

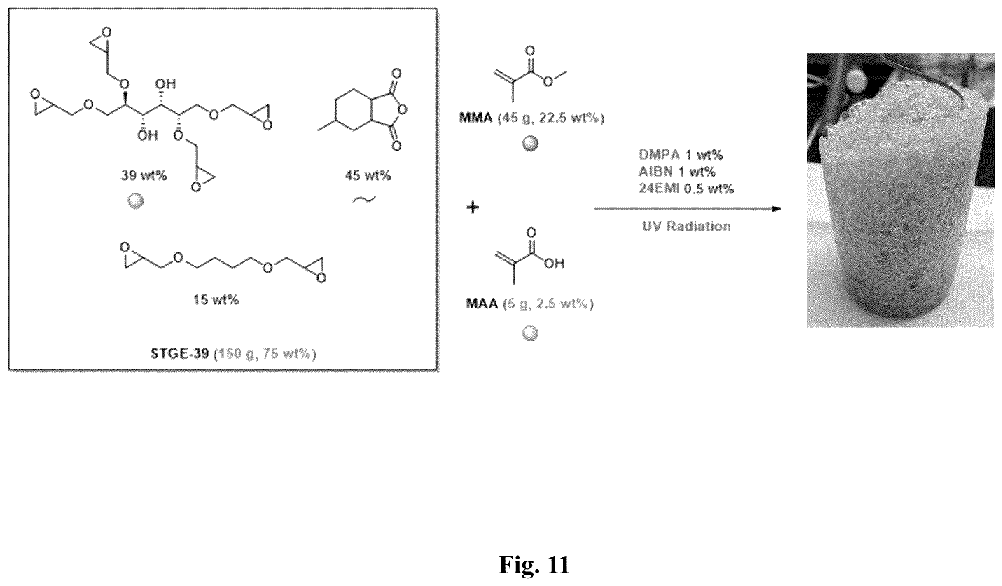

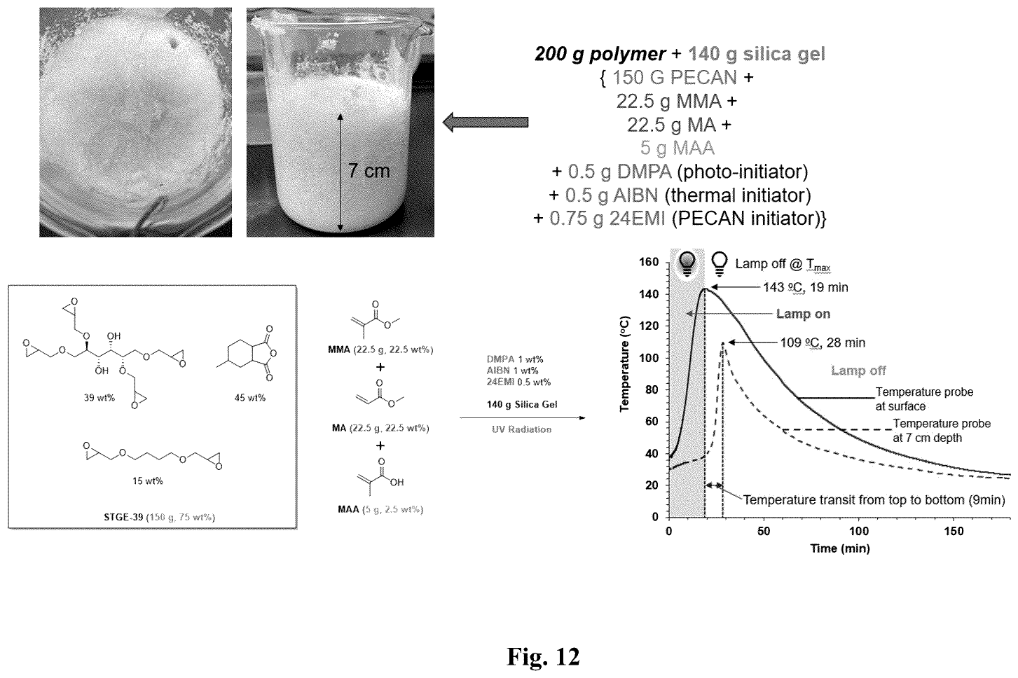

FIG. 6 provides Dynamic Scanning calorimetry isotherm (80° C.) curves for the polymerization of ethyl methacrylate (EMA) mixed in various compositional ratios (w/w) with PECAN STGE-39. The negative peaks (0-4 mins) represent the energy required to heat the solution to 80° C. The positive peaks thereafter represent the energy released by the EMA polymerization exotherm. Note that the PECAN catalyst (24EMI) is not employed here, so presumably no PECAN polymerization takes place and thus the exotherm can be attributed solely to the EMA reaction. The energy return is the integral of the exotherm, in other words the total energy produced by the EMA exotherm. These experiments show that the auto-acceleration (Trommsdorff) peak seen in the pure EMA run (black), which is a well-known characteristic of methacrylate polymerizations and causes rapid and problematic increases in temperatures, can be tempered by the addition of the step growth (PECAN) component. These data also suggest total compatibility between the two systems and a linear relationship between the composition ratio and energy return.

FIG. 12 illustrates photo-induced dual cure and chemical amplification where the curing object is opaque, i.e., not transparent or blocking light. 200 g of polymer with 140 g of silica gel is used to block passage of light. Temperature is measured at the surface and at 7 cm depth and a photo-initiator (DMPA) initiates free radical polymerization where light was accessible, presumably only at the surface. The sharp increase of temperature at time=0 for the surface thermal-probe and minimal change in temperature at 7 cm depth, indicates light is not penetrating down. The photo-initiated free radical polymerization at the surface produces chemical heating, which then induces activation of thermal initiator AIBN which can cause further polymerization but also moves the heat down into the depth (chemical amplification) so that temperatures >109° C. can be achieved throughout the bulk of the material, even when light is inaccessible.

The invention may be further understood by the following non-limiting examples:

### EXAMPLE 1

A method comprising:

providing one or more first reactants, wherein the one or more first reactants are capable of exothermic polymerization;
providing one or more second reactants, where in the one or more second reactants are capable of energy-demanding polymerization;
combining the one or more first reactants and the one or more second reactants in a vessel; and
reacting the one or more first reactants, thereby generating a first polymer and thermal energy;
wherein the thermal energy induces the one or more second reactants to react thereby generating a second polymer.

### EXAMPLE 2

The method of example 1, wherein the first polymer is covalently bound to the second polymer, thereby generating a tethered inter-penetrating network.

### EXAMPLE 3

The method of example 1 or 2 further comprising providing a free radical source; and

wherein the one or more first reactants are capable of exothermic free radical polymerization.

### EXAMPLE 4

The method of example 3, wherein the free radical source comprises A1BN or a redox amine/peroxide pair.

### EXAMPLE 5

The method of any of examples 1-4, wherein the one or more first reactants comprise one or more vinyl monomers.

### EXAMPLE 6

The method of example 5, wherein the one or more first reactants are polar vinyl monomers.

### EXAMPLE 7

The method of example 5, wherein the one or more vinyl monomers are selected from the group comprising acrylates, methacrylates, acrylamides, styrenes or a combination thereof.

### EXAMPLE 8

The method of example 5, wherein the one or more vinyl monomers are selected from methyl methacrylate, ethyl methacrylate, methacrylic anhydride, isobornyl acrylate, or a combination thereof.

### EXAMPLE 9

The method of any of examples 1-8, wherein the one or more first reactants further comprises a bonding reactant capable of forming a covalent bond with the second polymer.

### EXAMPLE 10

The method of example 9, wherein the bonding reactant is an anhydride, an epoxide, an alcohol, a carboxylic acid, an amine or a combination thereof.

### EXAMPLE 11

The method of any of examples 1-10, wherein the one or more second reactants comprise (2R,3S ,4S ,5S)-2- (cycloproylmethoxy)-1,5,6-tris (oxiran-2-ylmethoxy)hexane-3,4-diol (FX1), 5-methylhexahydroisobenzofuran-1,3-dione (FX2), 4-ethyl-2-methyl-1H-imidazole (FX3); 1,4-bis(oxiran-2-ylmethoxy)butane (FX4) or a combination thereof.

### EXAMPLE 12

The method of any of examples 1-11, wherein the one or more second reactants comprise PECAN polymer system.

### EXAMPLE 13

The method of any examples 1-12, wherein in the one or more first reactants and the one or more second reactants are provided in a ratio such that the solution comprising the one or more first reactants, the one or more second reactants, the first polymer and the second polymer stays below boiling temperature.

### EXAMPLE 14

The method of any of examples 1-13, wherein the one or more first reactants comprises a bonding agent;

wherein the one or more second reactants comprise one or more epoxides and one or more anhydrides and/or acrylates;
wherein the method further comprises providing a free radical source;
wherein the method further comprises providing a first group of reactants comprising: the one or more epoxides and the free radical source; and
providing a second group of reactants comprising the one or more anhydrides and/or acrylates and the one or more first reactants;
mixing the first group of reactants and the second group of reactants, thereby generating a tethered interpenetrating network.

EXAMPLE 15

The method of any of examples 1-14, wherein the one or more first reactants further comprise a photoinitiator; and

wherein said step of reacting the first reactants further comprises exposing the first reactants to electromagnetic radiation.

### EXAMPLE 16

The method of example 15, wherein the photoinitiator comprises 2,2-Dimethoxy-2-phenylacetophenone (DMPA).

### EXAMPLE 17

The method of example 15 or 16, wherein the electromagnetic radiation comprises light in the ultraviolet spectrum.

### EXAMPLE 18

A composition comprising:

a first polymer network; and
a second polymer;
wherein the second polymer is covalently bound to the first polymer network to form a tethered inter-penetrating network.

### EXAMPLE 19

The composition of example 18, wherein the first polymer network comprises a polymer formed by an endothermic reaction comprising the monomers (2R,3S,4S,5S)-2-(cycloproylmethoxy)-1,5,6-tris(oxiran-2-ylmethoxy)hexane-3,4-diol (FX1), 5-methylhexahydroisobenzofuran-1,3-dione (FX2), 4-ethyl-2-methyl-1H-imidazole (FX3); 1,4-bis(oxiran-2-ylmethoxy)butane (FX4) or a combination thereof.

### EXAMPLE 20

The composition of example 18, wherein the first polymer network comprises an polymer formed by an endothermic photoinitiated reaction comprising the monomers (2R,3S,4S,5S)-2-(cycloproylmethoxy)-1,5,6-tris(oxiran-2-ylmethoxy)hexane-3,4-diol (FX1), 5-methylhexahydroisobenzofuran-1,3-dione (FX2), 4-ethyl-2-methyl-1H-imidazole (FX3); 1,4-bis(oxiran-2-ylmethoxy)butane (FX4) or a combination thereof and a photoinitiator.

### EXAMPLE 21

The composition of any of examples 18-20, wherein the second polymer comprises a polymer formed by an exothermic free radical reaction comprising methacrylate monomers.

### EXAMPLE 22

The composition of example 21, wherein the methacrylate monomers comprise methyl methacrylate, ethyl methacrylate, methacrylic anhydride, isobornyl acrylate or a combination thereof.

The provided discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups, are disclosed separately. When a Markush group or other grouping is used herein, all individual members of the group and all combinations and subcombinations possible of the group are intended to be individually included in the disclosure. For example, when a device is set forth disclosing a range of materials, device components, and/or device configurations, the description is intended to include specific reference of each combination and/or variation corresponding to the disclosed range.

Every formulation or combination of components described or exemplified herein can be used to practice the invention, unless otherwise stated.

Whenever a range is given in the specification, for example, a density range, a number range, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter is claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A method comprising:
providing one or more first reactants, wherein the one or more first reactants are capable of exothermic polymerization;
providing one or more second reactants, where in the one or more second reactants are capable of energy-demanding polymerization;
combining the one or more first reactants and the one or more second reactants in a vessel; and
reacting the one or more first reactants, thereby generating a first polymer and thermal energy;
wherein the thermal energy induces the one or more second reactants to react thereby generating a second polymer.

2. The method of claim 1, wherein the first polymer is covalently bound to the second polymer, thereby generating a tethered inter-penetrating network.

3. The method of claim 1 further comprising providing a free radical source; and
wherein the one or more first reactants are capable of exothermic free radical polymerization.

4. The method of claim 3, wherein the free radical source comprises A1BN or a redox amine/peroxide pair.

5. The method of claim 1, wherein the one or more first reactants comprise one or more vinyl monomers.

6. The method of claim 5, wherein the one or more first reactants are polar vinyl monomers.

7. The method of claim 5, wherein the one or more vinyl monomers are selected from the group comprising acrylates, methacrylates, acrylamides, styrenes or a combination thereof.

8. The method of claim 5, wherein the one or more vinyl monomers are selected from methyl methacrylate, ethyl methacrylate, methacrylic anhydride, isobornyl acrylate, or a combination thereof.

9. The method of claim 1, wherein the one or more first reactants further comprises a bonding reactant capable of forming a covalent bond with the second polymer.

10. The method of claim 9, wherein the bonding reactant is an anhydride, an epoxide, an alcohol, a carboxylic acid, an amine or a combination thereof.

11. The method of claim 1, wherein the one or more second reactants comprise (2R,3S,4S,5S)-2-(cycloproylmethoxy)-1,5,6-tris(oxiran-2-ylmethoxy)hexane-3,4-diol (FX1), 5-methylhexahydroisobenzofuran-1,3-dione (FX2), 4-ethyl-2-methyl-1H-imidazole (FX3); 1,4-bis(oxiran-2-ylmethoxy)butane (FX4) or a combination thereof.

12. The method of claim 1, wherein the one or more second reactants comprise PECAN polymer system.

13. The method of claim 1, wherein in the one or more first reactants and the one or more second reactants are provided in a ratio such that the solution comprising the one or more first reactants, the one or more second reactants, the first polymer and the second polymer stays below boiling temperature.

14. The method of claim 1, wherein the one or more first reactants comprises a bonding agent;
wherein the one or more second reactants comprise one or more epoxides and one or more anhydrides and/or acrylates;
wherein the method further comprises providing a free radical source;
wherein the method further comprises providing a first group of reactants comprising: the one or more epoxides and the free radical source; and
providing a second group of reactants comprising the one or more anhydrides and/or acrylates and the one or more first reactants;
mixing the first group of reactants and the second group of reactants, thereby generating a tethered interpenetrating network.

15. The method of claim 1, wherein the one or more first reactants further comprise a photoinitiator; and
wherein said step of reacting the first reactants further comprises exposing the first reactants to electromagnetic radiation.

16. The method of claim 15, wherein the photoinitiator comprises 2,2-Dimethoxy-2-phenylacetophenone (DMPA).

17. The method of claim 15, wherein the electromagnetic radiation comprises light in the ultraviolet spectrum.

18. A composition comprising:
a first polymer network; and
a second polymer;
wherein the second polymer is covalently bound to the first polymer network to form a tethered inter-penetrating network.

19. The composition of claim 18, wherein the first polymer network comprises a polymer formed by an endothermic reaction comprising the monomers (2R,3S,4S,5S)-2-(cycloproylmethoxy)-1,5,6-tris(oxiran-2-ylmethoxy)hexane-3,4-diol (FX1), 5-methylhexahydroisobenzofuran-1,3-dione (FX2), 4-ethyl-2-methyl-1H-imidazole (FX3); 1,4-bis(oxiran-2-ylmethoxy)butane (FX4) or a combination thereof.

20. The composition of claim 18, wherein the first polymer network comprises an polymer formed by an endothermic photoinitiated reaction comprising the monomers (2R,3S,4S,5S)-2-(cycloproylmethoxy)-1,5,6-tris(oxiran-2-ylmethoxy)hexane-3,4-diol (FX1), 5-methylhexahydroisobenzofuran-1,3-dione (FX2), 4-ethyl-2-methyl-1H-imidazole (FX3); 1,4-bis(oxiran-2-ylmethoxy)butane (FX4) or a combination thereof and a photoinitiator.
